(19) United States
(12) Patent Application Publication
(10) Pub. No.: US 2007/0272823 A1
(43) Pub. Date: Nov. 29, 2007

(54) Apparatus For The Production Of Molded Concrete Pieces

(76) Inventor: Stephan Steffen, Bremen (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/572,629

(22) PCT Filed: Sep. 22, 2004
(86) PCT No.: PCT/EP04/10602

§ 371 Date: Dec. 7, 2006

(30) Foreign Application Priority Data
Sep. 22, 2003 (DE) 103 44 194.8

(51) Int. Cl. B28B 7/00

(52) U.S. Cl. 249/15

(57) ABSTRACT

An apparatus for the production of molded concrete building blocks (10), hollow concrete elements or the like, the apparatus having a mold frame (21) which has at least one mold cavity (14) into which concrete can be poured upright mold walls (15, 16) of the mold frame (21) bounding the mold cavity (14), and at least one scraping member (22) with which concrete can be scraped off on an exterior side of the molded piece, in order to form a roughened surface, preferably during an upward movement of the mold frame (21) while the molded pieces are being removed from the mold, with the scraping member (22), on a side facing the molded piece, having an exterior surface (24) which is at least partially curved in cross sections, and preferably of continuously curved design with a constant radius.

The concrete building blocks (10) produced in this manner have a roughened surface in the region of upright side surfaces (13), the roughened surface being of particular quality and, in particular, being of particularly uniform design.

The invention relates to an apparatus for the production of molded concrete pieces according to the precharacterizing clause of patent claim 1.

Molded concrete pieces, for example concrete building blocks with at least one roughened side surface, and corresponding apparatuses for producing the same are known from practice. During production of concrete building blocks of this type, an outer concrete layer is removed in the region of side surfaces of the molded pieces as they are being removed from the mold, so that a roughened surface is produced in this region.

The invention is based on the object of developing apparatuses of the type mentioned at the beginning, in particular in such a manner that the molded pieces produced therewith have an optimized roughened side surface.

To achieve this object, the apparatus according to the invention has the features of patent claim 1. According thereto, a characteristic feature consists in that the scraping member, on a side facing the molded piece, has an exterior surface which is at least partially curved in cross section. It has surprisingly been shown that the molded piece produced by the apparatus according to the invention has a more uniform and more attractive roughened side surface than the molded pieces produced with the known apparatuses.

The apparatus according to the invention is designed in such a manner that the scraping member is moved along the molded piece in the region or the roughened surface to be produced. This preferably takes place during demolding of the molded piece, namely when removing the mold frame upward. In the process, a preferably thin concrete layer is removed from the scraping member, as a result of which a roughened side surface is produced in the region of action of the scraping member. The apparatus according to the invention has the advantage that, during removal of the mold frame, less scraped-off concrete drops downward and, for example, drops onto a support board on which the concrete mold usually rests. The scraped-off concrete is removed from the molded piece together with the mold frame and is removed from the concrete mold before the next production step.

In a preferred embodiment of the invention, it is provided that the scraping member is assigned to a mold wall and at least partially protrudes in relation to this mold wall toward the interior of the mold cavity and has a front, free scraping edge which faces the molded piece. The material removed during the scraping of the concrete accumulates above this scraping member. According to a preferred development, the scraping member is part of the mold wall. In a preferred embodiment of the invention, the mold walls are of essentially closed design and, in particular, do not have any apertures, openings or the like.

The exterior surface of the scraping member is preferably of at least partially concave design in cross section. In a preferred exemplary embodiment, it is provided that the curved exterior surface of the scraping member extends continuously from the front, free scraping edge as far as the upright region of the mold wall. As an alternative, the curvature may also be limited to a partial region of the exterior surface. In addition, the curvature preferably has a constant radius, with it likewise being possible within the scope of the invention to provide variable radii or, if appropriate, even partial radii arranged in opposite directions.

In a preferred refinement of the invention, the scraping member is arranged in the region of a lower free edge of the mold wall and preferably extends continuously along the mold wall. The molded piece treated by the scraping member thereby has a roughened surface preferably continuously over the entire corresponding side surface.

According to a further preferred embodiment, each mold cavity has a respective scraping member on two opposite mold walls, so that the molded piece has a roughened surface on opposite side surfaces, in particular opposite visible surfaces. A corresponding arrangement may also be selected for further side surfaces of the molded piece. In the simplest embodiment, the concrete mold may have just one mold cavity. The arrangement of a multiplicity of mold cavities in a concrete mold is advantageous, with it being possible for each mold cavity to be assigned the desired number of scraping members. This procedure has the advantage that, in one working step, a multiplicity of concrete building blocks or the like can be produced that have roughened side surfaces (visible sides).

Further advantageous measures relate to the arrangement of protruding members, in particular knobs, in the region of the mold walls.

Further details of the production according to the invention of molded concrete pieces with roughened side surfaces are explained in more detail in the drawing with reference to an exemplary embodiment. In the drawing:

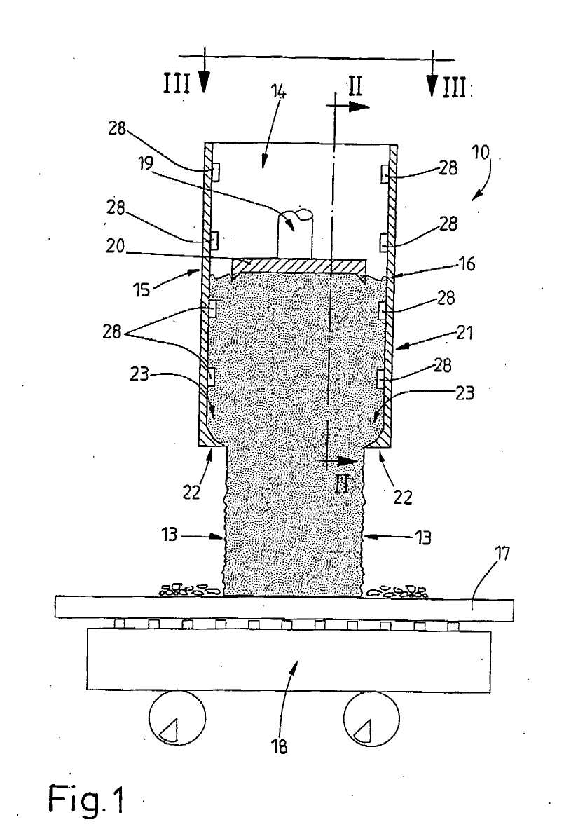

FIG. 1 shows, in a diagrammatic illustration, a concrete mold or part of the same in vertical section,

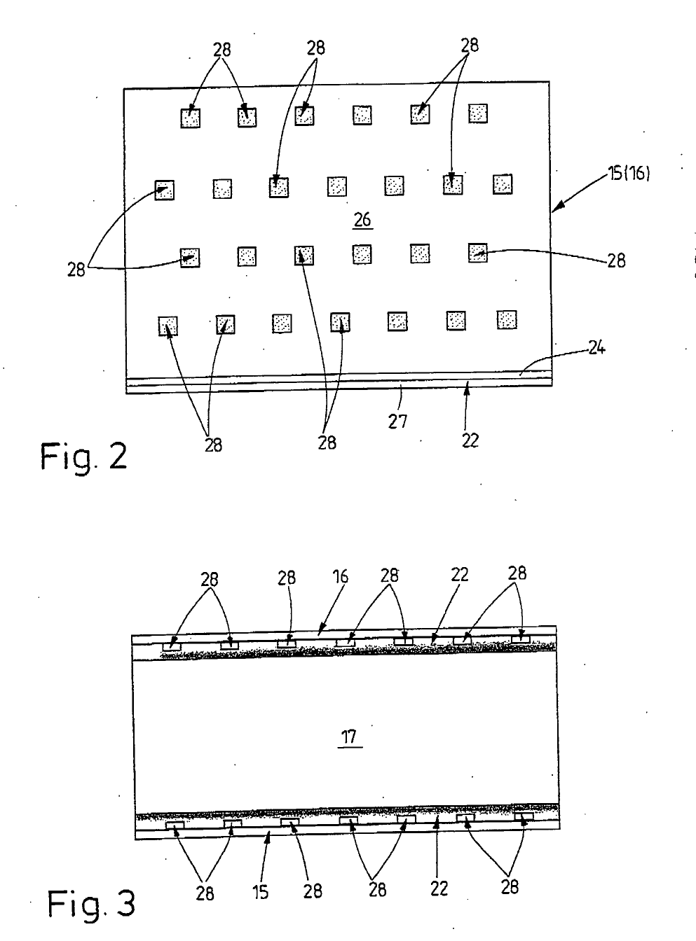

FIG. 2 shows a side view of a mold wall of the mold according to FIG. 1,

FIG. 3 shows a plan view of the mold according to FIG. 1,

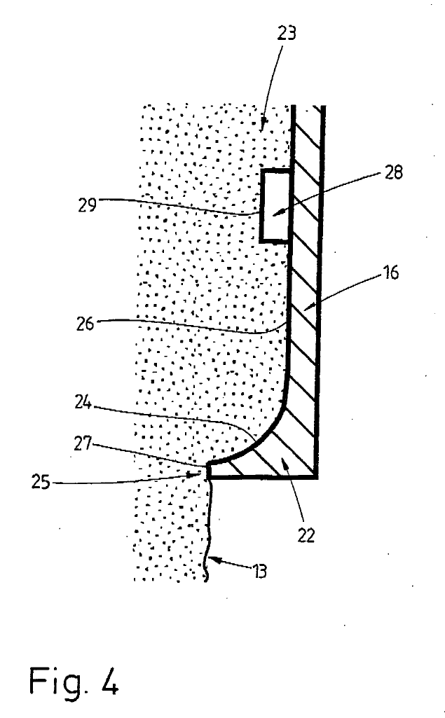

FIG. 4 shows an enlarged illustration of a scraping member of the mold according to FIG. 1,

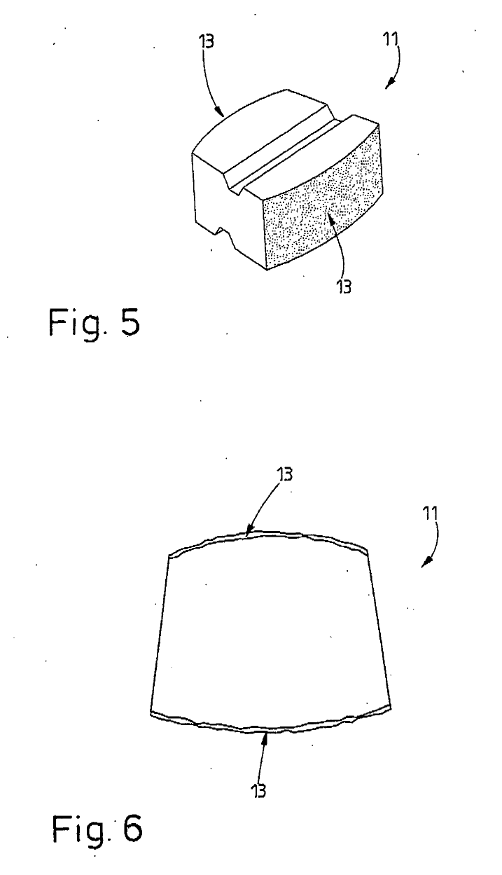

FIG. 5 shows, in a three-dimensional illustration, a molded piece produced with a mold according to the invention, and

FIG. 6 shows, in a diagrammatic illustration, a plan view of the molded building block according to FIG. 5.

The concrete mold 10, which is illustrated diagrammatically and in essential parts in the exemplary embodiment, serves for the production of molded concrete pieces, for example concrete building blocks 11, hollow concrete elements or the like. These have at least one side surface 13 with a roughened structure or surface formed by scraping off a thin concrete layer 12.

The molded pieces or concrete building blocks 11 are manufactured in the concrete mold 10 which, in a simplest embodiment, comprises an individual chamber or an individual mold cavity 14. This mold cavity 14 is enclosed laterally by upright mold walls 15, 16. The mold walls 15, 16 are of closed design. At least, they do not have any apertures, openings or the like in the regions which serve for the shaping of the side surfaces 13 of the molded piece.

FIGS. 2 and 3 show only some of the mold walls 15, 16, namely two opposite mold walls 15, 16, whereas the further mold walls which laterally close the mold cavity 14 are not illustrated. Generally, the mold walls 15, 16 will be arranged in a manner such that they encircle the mold cavity 14 and will completely surround the latter laterally. The mold walls 15, 16 therefore laterally bound the molded piece or concrete building block 11. The mold cavity 14 is open at the top and bottom.

The concrete mold 10 rests on a separate support, in the present case on a support board 17. The latter usually lies in turn on a vibrating table 18 for the compaction of the concrete poured into the concrete mold 10. The fresh concrete is poured from above into the concrete mold 10 or the mold cavity 14 while the concrete mold 10 rests on the support board 17. A ram 19 (partially illustrated) can be introduced from above into the mold cavity 14, with a ram plate 20 of the ram 19 resting on the concrete which has been poured in and shaping a top side or bottom side of the molded piece or concrete building block 10.

After the concrete is compacted in the mold cavity 14, the concrete building block 11 is removed from the mold. This takes place by raising the concrete mold 10, i.e. the mold walls 15, 16 which together form a mold frame 21 of the concrete mold 10. During this upward movement of the concrete mold 10, the molded piece or concrete building block 11 is fixed on the support board 17, namely by means of the ram 19 or its ram plate 20 which rests on the concrete building block 10. After the concrete mold 10 has been removed from the molded piece or concrete building block 11, the ram 19 is lifted off, so that the concrete building block 11 rests on the support board 17 and is free for transporting away.

The roughened surface or side surface 13 of the concrete building block 11 is produced during the removal of the concrete mold 10 from the molded piece, i.e. during the upward movement of the concrete mold 10. For this purpose, a scraping member 22 designed in a particular manner is provided, the scraping member moving along the exterior side of the molded piece. In the process, a concrete layer 23 is scraped off from the molded piece. The particular structure of the side surface 13 of the concrete building block 11 is produced by the scraped-off concrete 23 being moved along the side surface 13 of the concrete building block 11.

A visually particularly attractive design of the side surface 13 of the concrete building block 11 can be obtained by a special design of the scraping member 22. In the present exemplary embodiment, a respective scraping member 22 is arranged on both opposite mold walls 16 of the mold cavity 14. The scraping members 22 are arranged in each case at the lower free end of the mold walls 15, 16 and protrude in relation to said end toward the interior of the mold cavity 14. The scraping members 22 therefore form a lower termination of the mold walls 15, 16. According to the illustration in FIG. 4, the scraping member 22 is of curved design in cross section on the side facing the molded piece or the concrete building block 11. That side surface of the scraping member 22 which is of curved design and faces the molded piece is referred to below as the exterior surface 24. The exterior surface 24 extends from a front, free scraping edge 25, which faces the molded piece, of the scraping member 22 into the region of the upright side surface 26 of the mold wall 16.

In the exemplary embodiment shown, the exterior surface 24 is of continuously curved design, according to FIG. 4, to be precise with a constant radius. The scraping edge 25 has a front end surface 27 which faces the molded piece. It has been shown that this end surface 27 is to be as low as possible in height in order to provide an optimum appearance of the side surface 13 of the concrete building block 11. In the exemplary embodiment shown, the end surface 27 is approximately 5 mm high. Depending on the material used for the production of the mold walls 15, 16, the end surface 27 may also be lower or greater in height. Positive results have also already been obtained with a scraping member which is formed from sheet metal. The height of the end surface 27 corresponded in this case merely to the thickness of the sheet metal.

In the present case, the exterior surface 24 is of concavely curved design, namely is curved in the opposite direction to the direction in which the concrete mold 10 is removed. The exterior surface 24 is of continuously curved design, as in this case. However, as an alternative, the exterior surface 24 may also be of only partially curved design, for example with a first, rectilinear, inclined region which is arranged starting from the scraping edge 25 and then passes into a curved region. In addition to a constant radius, increasing or decreasing radii are also possible. These may also be combined with one or more rectilinear regions. The contour of the exterior surface 24 that is shown in FIG. 4 has proven advantageous in trials.

As is apparent from FIGS. 1 to 3, two scraping members 22 are arranged on opposite mold walls 15, 16 of the mold cavity 14. They run continuously over the entire length of the mold walls 15, 16. The rest of the mold walls of the mold cavity 14 may be free of scraping members 22, so that the concrete building block 11 has a roughened surface (visible side) on two opposite side surfaces 13. However, it is also conceivable for the scraping members 22 also to be arranged on the rest of the mold walls of the mold cavity 14, so that the concrete building block 11 has a roughened structure on a plurality of or all upright side surfaces 13.

A further characteristic feature of the concrete mold 10 illustrated in FIGS. 1 to 4 consists in that projecting elements are arranged on the upright mold walls 15, 16. The elements serve to hold the scraped-off concrete layer 13 on the mold walls 15, 16 during removal of the concrete mold 10. This prevents the scraped-off concrete 13 from dropping onto the support board 17 or onto the molded piece.

In the exemplary embodiment shown, the elements are knobs 28 which are square or rectangular in cross section. The knobs 28 are arranged in a row at a distance from one another, with a plurality of rows being provided one above another and running parallel to one another. The distances of the individual knobs 28 of a row from one another are preferably approximately identical in size, with the knobs 28 of adjacent rows being arranged offset with respect to one another, so that a uniform structure which is formed by the knobs 28 and is in the manner of a checkerboard is produced on the side surface 26. The protruding elements or knobs 28 are arranged above the scraping member 22 and extend laterally over a corresponding region of the mold walls 15, 16.

In the exemplary embodiment shown, the cuboidal knobs 28 have a planar end surface 29 which is directed toward the inside of the mold cavity 14 and runs parallel to the side surface 26 of the mold walls 15, 16. The end surfaces 29 of the knobs 28 are all situated in the same plane, with this plane being set back in relation to the plane of the end surface 27 of the scraping edge 25, i.e. projecting by a smaller extent toward the interior of the mold cavity 14. The end surfaces 29 of the knobs 28 may optionally be of roughened or, for example, scored design in order to improve the visual quality of the roughened side surface 13 of the concrete building block 11. The above-described distance of the end surface 29 of the knobs from the scraping edge 25 of the scraping member 22 also contributes to this.

The design of the knobs 28 may, of course, be varied, for example in order to produce different effects. For example, web-like formations, or protruding elements with a triangular visible side, the tip of which is directed in the direction in which the concrete mold 10 is removed, are conceivable.

The ram 19 or the ram plate 20 is dimensioned in such a manner and positioned within the mold cavity 14 in such a manner that a covering by the ram plate 20 is not provided laterally, namely adjacent to the mold wall 15, 16. This is the region of the concrete layer 12 which is entirely or partially scraped off. According to the illustration according to FIG. 1, it is apparent that the scraping members 22 can be moved past the ram plate 20.

The concrete building block 11, which is shown in FIGS. 5 and 6, with two opposite, roughened side surfaces 13 can be produced with a slightly modified concrete mold 10 according to FIGS. 1 to 4. As is apparent from FIGS. 5 and 6, the side surfaces 13 are of rounded design. In a corresponding manner, the mold walls 15, 16 have an arcuate design. In this case, the scraping members 22 are also to be of curved design in the longitudinal direction corresponding to the contour of the concrete building block 11.

As in the exemplary embodiment shown, the concrete mold 10 may have just an individual mold cavity 14. As an alternative, the concrete mold 10 may also contain a plurality of mold cavities 14 arranged in a row. It is furthermore conceivable for a plurality of parallel rows of mold cavities 14 to be provided within a concrete mold 10. In this case, each mold cavity 14 is assigned the desired number of scraping members 22, so that all of the concrete building blocks 11 in the mold cavities 14 are worked on simultaneously by concrete being scraped off.

### LIST OF REFERENCE NUMBERS

10 Concrete mold
11 Concrete building block
12 Concrete layer
13 Side surface
14 Mold cavity
15 Mold wall
16 Mold wall
17 Support board
18 Vibrating table
19 Ram
20 Ram plate
21 Mold frame
22 Scraping member
23 Concrete layer
24 Exterior surface
25 Scraping edge
26 Side surface
27 End surface
28 Knob
29 End surface

1. An apparatus for the production of molded concrete pieces, in particular concrete building blocks (10), hollow concrete elements or the like, a mold frame (21) being provided which has at least one mold cavity (14) into which concrete can be poured and which is at least partially bounded by upright mold walls (15, 16) of the mold frame (21), and, furthermore, the mold cavity (14) being assigned at least one scraping member (22) with which concrete can be scraped off on at least one exterior side of the molded concrete pieces, in order to form a roughened surface (13), in particular during an upward movement of the mold frame (21) while the molded concrete pieces are being removed from the mold, characterized in that the scraping member (22), on a side facing the molded piece, has an exterior surface (24) which is at least partially curved in cross section.

2. The apparatus as claimed in claim 1, characterized in that the scraping member (22) is assigned to a mold wall (15, 16) and at least partially protrudes in relation to this mold wall (15, 16) toward the interior of the mold cavity (14) and has a front, free scraping edge (25) which faces the molded concrete piece.

3. The apparatus as claimed in claim 2, characterized in that the exterior surface (24) of the scraping member (22) has an at least partially curved profile in cross section in the region between the scraping edge (25) and the upright mold wall (15, 16).

4. The apparatus as claimed in claim 1, characterized in that the exterior surface (24) of the scraping member (22) is of at least partially concave design in cross section.

5. The apparatus as claimed in claim 2, characterized in that the exterior surface (24) of the scraping member (22) has a continuously curved profile in cross section in the region between the scraping edge (25) and the upright mold wall (15, 16).

6. The apparatus as claimed in claim 1, characterized in that the curvature of the exterior surface (24) has a constant radius.

7. The apparatus as claimed in claim 1, characterized in that the scraping member (22) is arranged in the region of a lower free edge of the mold wall (15, 16) and extends in particular continuously along the mold wall (15, 16).

8. The apparatus as claimed in claim 1, characterized in that scraping members (22) are arranged on at least two opposite mold walls (15, 16) of a mold cavity (14), for the simultaneous formation of a roughened surface on corresponding opposite side surfaces (13) of the molded piece.

9. The apparatus as claimed in claim 1, characterized in that the scraping member (22) is part of the mold wall (15, 16).

10. The apparatus as claimed in claim 1, characterized in that a ram (19) entering a the mold cavity (14) on a top side of the mold frame (21) has a ram plate (20) which, in the region of the scraping member (22), has such a lateral distance from the adjacent mold walls (15, 16) that the scraping member (22) can be moved past the ram plate (20) during the removal of the molded concrete piece from the mold.

11. The apparatus as claimed in claim 1, characterized in that the concrete carried along by the scraping member (22) during removal of the molded pieces from the mold can be removed upward out of the mold cavities cavity (14).

12. The apparatus as claimed in claim 1, characterized in that the mold walls (15, 16) are of closed design, in particular in such a manner that the mold walls (15, 16) do not have any recesses, apertures or the like.

13. The apparatus as claimed in claim 1, characterized in that knob (28) elements protrude towards the interior of the mold cavity (14) and are arranged in the region of the upright mold walls (15, 16).

14. The apparatus as claimed in claim 13, characterized in that the knob (28) elements are arranged in a number of parallel rows one above another, the members of one row being arranged at a distance from one another, with uniform or regular distances between one another.

15. The apparatus as claimed in claim 13, characterized in that the knob (28) elements of adjacent rows are arranged offset with respect to one another in a staggered manner to one another.

16. The apparatus as claimed in claim 13, characterized in that the knob (28) elements have a cuboidal design.
